(19) United States
(12) Patent Application Publication
(10) Pub. No.: US 2024/0311892 A1
(43) Pub. Date: Sep. 19, 2024

(54) System and Method for Catalog Data Enrichment

(71) Applicant: Klevu Oy, Espoo (FI)

(72) Inventors: Niraj Aswani, St Albans (GB); Nilay Oza, London (GB)

(21) Appl. No.: 18/184,609

(22) Filed: Mar. 15, 2023

(51) Int. Cl. G06Q 30/0601

(52) U.S. Cl. CPC G06Q 30/0629

(57) ABSTRACT

Disclosed herein is a system and a computer implemented method that aims to improve the quality of product information on an online ecommerce store by enriching the catalog data. This is achieved by analyzing free form user search queries and grouping them into domain clusters. A domain specific context is then generated for each cluster and used to enrich the product catalog data. Each product category in the product catalog data is assigned to a specific domain cluster and enriched with relevant information based on the domain specific context and class relations derived from a product ontology. The goal of this process is to provide more relevant search results for users and improve the overall shopping experience on the ecommerce store.

### TECHNICAL FIELD

This disclosure relates generally to computer systems and processes for online ecommerce, and, more particularly, to enriching digital catalog data processing using automated means for enhancing ecommerce search engine performance.

### BACKGROUND

E-Commerce has grown exponentially in the present times with an ever growing number of online shopping transactions taking place every second through ecommerce storefronts. People prefer to search for their desired products online, from the comfort of their homes, rather than checking out the products at a physical store. However, one of the most bothersome issues faced by the online shoppers is the unavailability of results based on their search query. This primarily happens on account of the user search query defining the product, as per the said search query, differently as compared to description of the said product in the product catalog provided by the merchant. As an example, a user search query of outdoor furniture might not retrieve a garden table from the database on account of difference in search query and product details. This leads to poor recall of the search engine. Despite product catalog data consuming memory space, the information is not retrieved by the search engine on account of poor recall, thereby leading to inefficient utilization of computing resources and electrical power since there would be a greater number of searches being performed to retrieve the right set of results.

Conventionally, the problem described above is solved using enriching the data at the backend so that better results can be fetched by the search engine pursuant to user queries. One method of said enrichment is adding words that shoppers use in their queries while searching for a specific product. This helps in identifying alternative words for the product noun, supplementing product catalog data with identified synonyms and thereby retrieving relevant product search results from a user search query.

However, the above mentioned method is limited in scope due to the vast number of product catalog data. It is highly inefficient and time-consuming to manually add synonyms to different product catalogs. Further, the synonyms provided by the merchant are not comprehensive enough to cater to ever growing patterns of user search queries.

In light of above mentioned problems, there does not exist a solution that provides a high recall for information retrieval through search engines associated with ecommerce online storefronts and it is highly desirable that a system and method for backend data enrichment in an automated manner is provided in order to enhance the search engine performance by improving the recall and relevance of search results.

### SUMMARY

The present disclosure seeks to provide a system and a computer implemented method for automated catalog data enrichment for products being listed on an online ecommerce store. The enriched catalog data results in a higher number of relevant search results pursuant to a user search query. The method disclosed herein comprises creating a plurality of pre-computed domain clusters by processing free form user search queries. A domain specific context is generated for each of the plurality of domain clusters. Each logical collection of products (also known as a product categories) in a product catalog data, when presented to the said system, is parsed and subsequently assigned to a distinct domain cluster. The domain specific context is associated with each such product category in the product catalog data based on the identified domain and the product catalog data is enriched with one or more enrichments based on the domain specific context and one or more class relations derived from a product ontology.

In yet another aspect of the present invention, a method for search engine performance enhancement is provided wherein the search engine is connected to the enriched product catalog data and thereby configured to display higher number of relevant results pursuant to a user search query.

Embodiments of the present disclosure substantially eliminate or at least partially address the aforementioned problems.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts the block diagram of the exemplary system as per the present disclosure.

FIG. 2 is a flow chart depicting the method steps of the present invention.

It will be appreciated that the drawings illustrated herein are for representation purposes only and do not intend to limit the scope of the present disclosure, and actual implementation of the present disclosure may be viewed substantially differently.

### DETAILED DESCRIPTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

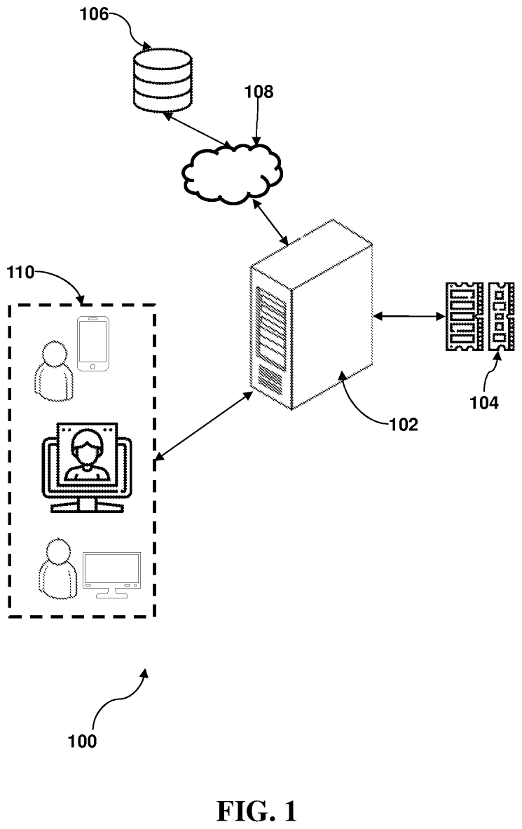

Referring to FIG. 1, the system 100 comprises a processor 102 with a memory 104 comprising executable non-transitory machine readable instructions wherein the processor 102 is configured to execute the said machine readable instructions. The processor 102 is configured to enrich catalog data, associated with a product, with one or more enrichments based on an identified domain for each product category in the product catalog data. The system 100 further comprises one or more data stores 106 that stores the enriched catalog data and is communicably coupled to the processor 102 through a data communication network 108. The catalog data is received through one or more client devices 110 communicably coupled to the processor 102, intending to list products for sale on an ecommerce store.

Throughout this disclosure, the term “catalog data” refers to information about products that are offered for sale on an online platform and related material (e.g. blogs, articles, white papers, user guides and instructions about the products), such as an ecommerce store. This information may include product titles, descriptions, specifications, images, pricing, and availability. A “product category” refers to the collections and sub-collections of products created by the merchants for easy navigation and discovery of products. For example, a store may have product categories such as clothing, footwear and home decor as well as sub-categories such as for men, women, kids, lighting, furniture etc. The catalog data serves as the foundation for the online store's product offerings and is used to provide information to customers as they search and browse the platform. The goal of catalog data is to accurately and effectively communicate the details of a product to potential customers, making it easier for them to find the products they are interested in and make informed purchasing decisions. The catalog data is provided by a merchant who intends to sell the product on the ecommerce store. The catalog data provides information related to the product and comprises product title, product id, product description, product attributes.

The product title generally comprises one or more nouns describing the product. It provides specific information about the product's characteristics and features. For example, a product noun might be “t-shirt,” “laptop,” “chair,” “doll,” “novel,” etc. By having a clear and accurate product noun, online stores can provide more specific and detailed information about their products, making it easier for customers to find the products they are looking for and make informed purchasing decisions. Product descriptions are usually used for explaining product aspects such as suitability criteria. For example, good for a business meeting, suitable for a child, outdoor usage, vintage look, party dress etc. Product attributes, on the other hand, are specific characteristics or features of a product that help to describe and differentiate it from other products. In catalog data, product attributes provide detailed information about the product and can include information such as color, size, weight, material, brand, model number. For example, a customer searching for a new pair of shoes might be looking for specific attributes such as color, size, brand, and style.

The processor 102 is configured to receive from a merchant, through the one or more client devices 110, a catalog data associated with a product to be listed on an ecommerce store. As per the exemplary embodiment of the present invention, the catalog data associated with the product comprises at least one product title. The catalog data is received from the merchant, in free-form text using a user interface coupled to the one or more client devices 110. Alternatively, the catalog data can be provided in the form of a PDF(Portable Document Format) document and the catalog data is then extracted, using OCR(Optical Character Recognition), in text form from the PDF document. Further, the catalog data is provided in form of speech and is then converted to text using speech-to-text converters.

The processor 102 is configured to process the received catalog data wherein said processing comprises tokenizing text of the catalog data into a plurality of individual tokens. For example, consider a product catalog data entry that includes the following information:
“Apple iPhone 12, 64GB, Black, 5G, Unlocked”
   This product information could be tokenized into the following individual tokens:
Apple
iPhone
12
64
GB
Black
5G
Unlocked
   Tokenizing the catalog data can be done using various techniques, such as using regular expressions, machine learning algorithms, or natural language processing techniques.

Once the catalog data is tokenized into plurality of individual tokens, each of the individual tokens is pre-processed by the processor 102. In an embodiment of the present invention, the pre-processing comprises at least one or more of the following processes:
a. Decompounding
b. Normalizing the words to their root form using a relevant Lemmatizer
c. Stopword filtering

Decompounding refers to the process of breaking down a compound word into its individual constituent parts. A compound word is a word that is made up of two or more words, which are combined to form a single word with a new meaning. For example, the compound word “toothbrush” is made up of the words “tooth” and “brush”. Decompounding involves breaking down this compound word into its two constituent parts, “tooth” and “brush”. In languages such as Swedish, often when the words are combined, infixes are used (e.g. s) or some words change their form. As part of the decompounding process, we also take care of normalising these words and removing any infixes and/or suffixes present. Examples:

Förvaringsburk =>förvaring=>burk
släpvagnskontakt =>släpvagn =>kontakt

A lemmatizer is a tool used in natural language processing (NLP) to reduce words to their base or root form. The goal of lemmatization is to reduce the dimensionality of the data, by reducing variations of words that have the same meaning to a common base form. For example, the words “running”, “ran”, and “runs” are all forms of the verb “run”, and a language specific lemmatizer would reduce them all to the base form “run”. Similarly, the words “better” and “best” are forms of the adjective “good”, and a lemmatizer would reduce them to the base form “good”. Lemmatization is important in NLP tasks such as text classification, information retrieval, and machine translation, because it helps to improve the accuracy of the analysis by reducing variations of words to their base form. Lemmatizers typically use morphological analysis, which involves analyzing the structure of words, and knowledge of the language's lexicon, or vocabulary, to determine the base form of a word. They can also take into account the context in which the word is used to determine the appropriate base form.

Stopword filtering is a technique used in natural language processing (NLP) to remove words from text data that are deemed to be unimportant for the analysis. Stopwords are common words that appear frequently in text data but do not carry much meaning. These words can be prepositions, conjunctions, articles, and other function words that are common in a language. Stopword filtering is used in NLP tasks such as text classification, information retrieval, and text mining, to reduce the size of the data and improve the performance of the analysis. By removing stopwords, the remaining words in the text become more meaningful, making it easier to identify patterns and relationships in the data. For example, if a user searches for “the best toothbrush”, the stopword filtering process would remove the stop word “the” , leaving only “best” and “toothbrush” as the remaining words in the search query. Stopword filtering is language specific, meaning that the list of stopwords used for filtering will vary based on the language being analyzed. Some common stopwords in English include “the”, “and”, “a”, “an”, “in”, “of”, and “to”.

The processor 102 is further configured to identify a domain for each product category in the catalog data using a domain classifier. In the context of trade and e-Commerce, the domain of a product refers to the category or type of product. It represents the general area of interest that the product belongs to, and provides information about the product's features, specifications, and intended use. For example, a product's domain in the context of e-Commerce could be electronics, clothing, footwear, home goods, etc.

The processor 102 is configured to identify, based on a domain classifier, a domain for each product category in the catalog data based on a most similar match with one or more pre-defined set of clusters. In the context of this disclosure, the term “domain” of a product refers to the category or industry that the product belongs to. For example, if the product is a smartphone, the domain might be “electronics” or “mobile devices.” Similarly, if the product is a dress, the domain might be “fashion” or “apparel.”

The one or more pre-defined clusters are a set of words/phrases grouped together representing a distinct domain such as apparel or electronics. The clusters are logical groupings of terms that are similar to one another and often appear within the same search context. As such, each of the one or more pre-defined clusters comprises words that are semantically similar to one another and representative of at least one distinct domain. For example, “running shoes”, “athletic footwear”, “formal shoes”, “slippers” etc. are all search queries relevant to the same domain “footwear” with the words “shoes”, “slippers”, “footwear” and similarly “running” and “athletics” having a similar meaning to each other. In an embodiment of the present invention, the processor 102 is operable to receive a plurality of free-form search queries from several online storefronts. Each of the said plurality of free-form search queries is pre-processed to generate n-grams. Clustering using n-grams is a technique used in text processing and information retrieval to group similar text segments into clusters. N-grams are contiguous sequences of n items from a given sample of text. In the context of clustering, n-grams are used as the basic building blocks for grouping similar text segments. For example, consider a set of free from queries. To cluster these queries using n-grams, the first step would be to tokenize the search queries into individual words or sequences of words. Then, n-grams are extracted from these tokens, where n is a specified value (e.g. 1 for unigrams, 2 for bigrams, 3 for trigrams, etc.).

Once the n-grams are extracted, unigrams that are stopwords, numbers, punctuations or grams ending or starting with stopwords are filtered out. The remaining extracted n-grams are then used as the features for clustering. The clustering algorithm groups the n-grams of one store with the other based on their similarity, within a distinct cluster thereby resulting in a set of clusters that represent similar patterns in the text. This clustering can then be used to group the tokens into similar categories, or to identify common themes or patterns across the tokens. Each of the formed clusters is tagged to a specific domain based on a user input. As a non-limiting example of said clustering, clusters with domain names such as Clothing, Electronics, Footwear etc are tagged.

In yet another aspect of the present invention, the semantically similar terms appearing in free-form search queries that are grouped together within a cluster are referred to as domain specific context. The term “domain specific context” refers to a set of words/phrases that appear along with the search queries relevant to the particular domain. Semantically similar terms refer to words or phrases that have a similar meaning, despite having different wording. For example, the words “automobile,” “car,” and “vehicle” are semantically similar because they all refer to a type of transportation. Therefore, for each domain, the domain specific context comprises a set of words that are frequently used in search queries for products related to the said domain.

By comparing the pre-processed individual tokens against the pre-defined set of clusters, the domain classifier can determine the most relevant domain for each product category in the catalog data. In operation, a cluster that has the highest number of matching terms as compared with the individual tokens extracted from product category in the catalog data is selected as the most similar cluster and correspondingly a domain tagged to the said cluster is identified as the domain for the respective product category in the catalog data.

The processor 102 is further configured to determine one or more enrichments for the catalog data based at least on the domain specific context or one or more class relations of the catalog data identified from a product ontology or merchant provided synonyms.

Throughout this disclosure, the term “enrichments” refers to supplementation of a word or phrase by adding additional information or context to it. Additional representation of the word, synonyms, hypernyms, transliterations and translations amongst other things are a few examples of enrichment within the scope of this disclosure. Synonyms are words or phrases that have a similar meaning to another word or phrase. For example, if the product catalog data includes the word “shoes”, a synonym enrichment might replace it with “footwear” or “boots”. This can help to expand the range of search queries that will return the product in the results. Hypernyms are words that describe a broader category of which a given word is a part. For example, if the product catalog data includes the word “running shoes”, a hypernym enrichment might replace it with “athletic footwear”. This can help to improve the relevance of search results for users who are looking for a specific type of shoe. Translation involves converting words or phrases from one language to another. For example, if the product catalog data includes a product name in French, a translation enrichment might provide an English translation of the name to help users who are searching in English. Transliteration involves converting words or phrases from one writing system to another. For example, if the product catalog data includes a product name written in Chinese characters, a transliteration enrichment might provide a Romanized version of the name to help users who are searching using the Latin alphabet.

The processor 102 identifies, using a POS tagger, a grammatical category for each of the plurality of pre-processed tokens of the catalog data. A POS tagger, also known as Part of Speech tagger, is a program that labels each word in a text corpus with a part-of-speech tag, such as noun, verb, adjective, adverb, pronoun, preposition, conjunction, or interjection. The part-of-speech tag reflects the grammatical function of the word in a sentence. POS tagging is an important task in natural language processing (NLP) because it enables applications such as text analysis, information retrieval, and machine translation to better understand the meaning and context of words in a text. There are several techniques used to build POS taggers, including rule-based systems, statistical models, and neural networks. These models can be trained on annotated datasets of text, where each word is manually labeled with its part-of-speech tag. Once the tagger is trained, it can be used to automatically label new text with the appropriate tags.

The processor 102 implements POS tagging on the catalog data fed in the form of a stream of pre-processed tokens. The processor 102 tags each of the plurality of pre-processed tokens of the catalog data with a grammatical category. The term “grammatical category” refers to the various parts of speech that are used in a language. These categories include nouns, verbs, adjectives, adverbs, pronouns, prepositions, conjunctions, and interjections. Each of these categories plays a different role in the sentence, and POS tagging is used to identify which part of speech each word in a sentence belongs to. As a non-limiting example, if catalog data includes the words “leather jacket”, the processor 102 can identify, based on POS tagging, that “leather” is an adjective and “jacket” is a noun. This information can be used to enrich the catalog data by identifying that the product is made of leather, which could be a key feature for customers searching for a leather jacket. Similarly, if the catalog data includes the phrase “water-resistant fabric”, the processor 102 can identify, based on POS tagging, that “water-resistant” is an adjective modifying the noun “fabric”. This information can be used to enrich the catalog data by including a feature indicating that the product is made of water-resistant fabric, which could be an important consideration for customers looking for outdoor gear or rainwear.

Subsequent to the identification of the grammatical category for each of the plurality of token of the catalog data, the processor 102 is operable to obtain one or more synsets for each of the tokens pursuant to the identified grammatical category. The term “Synsets” refers to sets of synonyms or closely related words that are grouped together based on their meanings. They are commonly used in lexical databases, such as WordNet, which is a popular English lexical database. A synset is a group of words that have the same meaning or are closely related in meaning, and each synset is assigned a unique identifier. Non-limiting examples of said synset are provided below:
Word: “shoe”
Synset: {footwear, shoe, skid}
   Further, based on the grammatical category, a word can have different synsets. As depicted below:
   The word “bank” has multiple synsets for both its noun and verb forms.
   Here are a few examples:
Synsets for “bank” as a noun:
   (n) bank, depository financial institution, banking concern, banking company (a financial institution that accepts deposits and channels the money into lending activities)
   (n) bank (a long ridge or pile)
   (n) bank (sloping land (especially the slope beside a body of water))
Synsets for “bank” as a verb:
   (v) bank (tip laterally)
   (v) bank (enclose with a bank)
   (v) bank (do business with a bank or keep an account at a bank)

It shall be appreciated by person skilled in the art that these are just a few examples and there may be more synsets for each usage of the word “bank.” As depicted in the above example, for a distinct grammatical category there are more than one synsets for the words.

In an aspect of the present invention, the processor 102 is configured to select a suitable synset out of the one or more synsets for each of the plurality of token of the catalog data. The term “suitable synset” refers to the synset with highest semantic similarity with the domain specific context. Identifying suitable synset helps in relevant results being displayed pursuant to user search query for a specific product.

The processor 102 is configured to create a target document for each of the one or more synsets identified for each of the plurality of tokens from the catalog data. The target document comprises all terms retrieved from the synset for the said token in its tagged grammatical category. Further, the processor 102 is operable to create a source document for the catalog data wherein the source document comprises the domain specific context for the respective product category the current stream of tokens belong to as well the pre-processed tokens from the catalog data.

The suitable synset is selected, by the processor 102, based on the highest semantic similarity with the domain specific context. The processor 102 is configured to use a pretrained AI model to compute similarity between each of the target documents and the source document. Based on the computed similarity, the target document with the highest similarity is determined and the synset corresponding to the said target document is selected as the suitable synset. The tokenized text in the target document and the source document is fed into the pre-trained AI model. The pre-trained AI (artificial intelligence) model generates contextualized word embeddings, which capture the meaning of each word in the context of the entire text. These embeddings are then used to compute a similarity score between the two pieces of text. In an embodiment of the present invention, the pre-trained AI mode is BERT (Bidirectional Encoder Representations from Transformer). It shall be appreciated that other AI models for computing semantic similarity are well within the scope of this disclosure.

In an aspect, the processor 102 is configured to add the content of target document corresponding to the selected suitable synset as enrichments to the received catalog data.

Optionally, the processor 102 is further configured to identify, based on the catalog data, one or more class relations from a product ontology. A product ontology is a hierarchical representation of a set of products and their relationships to one another. It provides a structure for organizing and categorizing products based on their properties, features, and functions. In a product ontology, products are represented as nodes in a tree-like structure, with each node representing a particular category or aspect of the product. The relationships between products are represented by edges connecting the nodes, which can represent relationships such as inheritance, part-of, or has-a.

Further, the term “class relations” refers to the relationships between different product categories or classes. These relationships help to define the hierarchical structure of the product ontology and capture the relationships between products based on their properties, features, and functions. There are several common types of class relations in product ontologies, including :
Inheritance: This relationship represents a subcategory of products that inherits properties, features, and functions from a more general category. For example, a class for “sport utility vehicles” might inherit properties from a more general class for “vehicles.”
Part-of: This relationship represents a relationship between a product and a larger whole. For example, a class for “tire” might have a part-of relationship with a class for “automobile.” Has-a: This relationship represents a relationship between a product and its components. For example, a class for “laptop” might have a has-a relationship with a class for “keyboard.”

By identifying said class relations from a product ontology, the processor 102 can capture the relationships between products and provide a more structured and meaningful representation of the products. As such, the processor 102 can identify one or more enrichments for the catalog data based on the synonyms, hypernyms, and other representations or a category, a type or attributes of the product which has a direct association in the product ontology. As a non-limiting example, a catalog data consisting of the following:

### Iphone Cover

Based on the above catalog data, the processor 102 identifies that “Iphone” is connected to Mobiles with “is-a” relation in the product ontology. Therefore, “iPhone” keyword shall be enriched with all representations, synonyms, hypernyms, and translations of the product “mobile”. Similarly, keyword “cover” shall be enriched with class relations identified from the product ontology for the word “cover”.

In an embodiment of the present invention, the product ontology as per the present disclosure is expanded based on the identified one or more enrichments for the catalog data. Concepts and class relations that are not previously present in the product ontology are added based on new concepts or class relations from received catalog data.

Optionally, the one or more enrichments comprises merchant provided synonyms that are provided by the merchants during onboarding and submission of the catalog data to an ecommerce store. In many cases, the merchant provided synonyms act as useful enrichment covering local translations, custom names and transliterations.

The processor 102 is operable to add one or more enrichments, based on the selected suitable synset, class relations from the product ontology and the merchant provided synonyms, for each of the plurality of pre-processed token from the catalog data. The catalog data is enriched with the one or more enrichments and stored, by the processor 102, on a data store 106 communicably coupled with the processor 102 through a data communication network.

The data stores 106 , in context of the present disclosure, are various types of data storage systems used to store and manage data during processing. Non-limiting examples of said data stores are relational databases and No-SQL databases, data warehouses, file systems. The processor 102 is operable to store the enriched catalog data on the data stores.

The processor 102 comprises a memory configured to store the domain specific context for each domain and the product ontology.

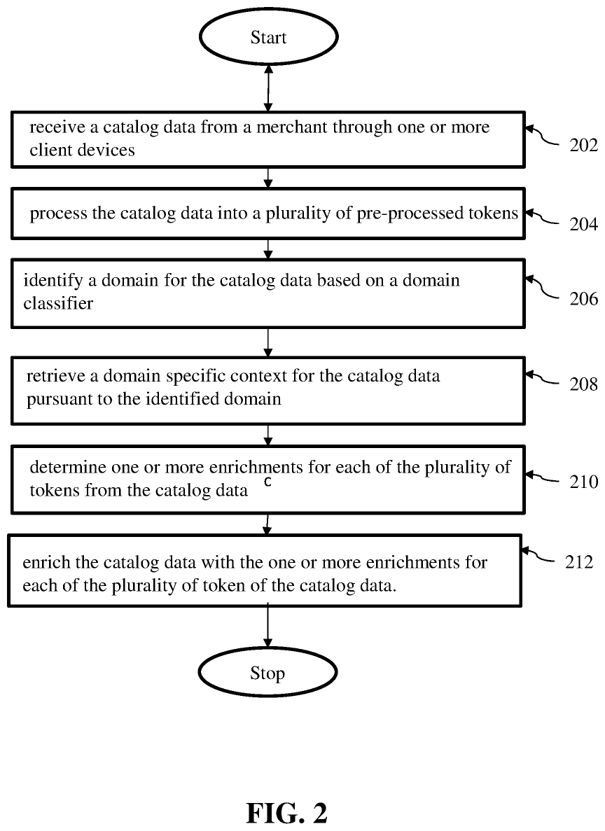

FIG. 2 depicts a flow chart 200 for the computer implemented method steps of the present invention. At step 202, the processor 102 receives catalog data from a merchant through one or more client devices 110. At step 204, the processor 102 processes the catalog data into a plurality of pre-processed tokens. At step 206, the processor 102 identifies a domain for each category in catalog data based on a domain classifier. At step 208, the processor 102 retrieves a domain specific context for each category in the catalog data pursuant to the identified domain. At step 210, the processor 102 determines one or more enrichments for each of the plurality of tokens from the catalog data. Finally, at step 212, the processor 102 enriches the catalog data with the one or more enrichments for each of the plurality of token of the catalog data.

In another embodiment of the present invention, a system for enhanced search is disclosed that outputs, pursuant to a user search query, relevant product listings and has a large recall. The system for enhanced search comprises a processor 102 configured to generate one or more product listings based on an input search query wherein the processor 102 is communicably coupled to the one or more data stores 106 with enriched catalog data. The processor 102 primarily is a search engine module that indexes product catalog data and uses algorithms to match customer queries with relevant products. The processor 102 typically uses natural language processing techniques to understand customer queries and retrieves relevant product information from the data store 106. Since the data store 106 comprises enriched catalog data, the search engine is able to retrieve relevant products with a wide recall.

In yet another aspect, there is disclosed one or more non-transitory storage media comprising computer-executable instructions that, when executed by a processor 102, cause the processor 102 to:
receive a catalog data associated with the product wherein the catalog data comprises at least a product title;
process the catalog data into a plurality of tokens wherein each of the plurality of token are pre-processed;
identify a domain for each category in the catalog data based on a domain classifier;
retrieve a domain specific context for the catalog data wherein the domain specific context is based on the domain; determine one or more enrichments for each of the plurality of tokens;
enrich the catalog data by adding one or more enrichments for each of the plurality of tokens.

The one or more client devices may comprise any type of computing device, such as a desktop computer system, a laptop, cellular phone, a smart device, a mobile telephone, a tablet style computer, or any other device capable of wireless or wired communication. In some implementations, the one or more client devices are configured to interact with the processor 102 via an application, such as a web browser or a native application, residing on the client device.

The data communication network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of the foregoing.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components. A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor 102 includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor 102 using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order.

Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

We claim:

1. A computer implemented method for enhancing search engine recall based on automated catalog data enrichment of a product, the method comprising:
receiving a catalog data associated with the product wherein the catalog data comprises at least a product title;
processing the catalog data into a plurality of tokens wherein each of the plurality of token are pre-processed;
identify a domain for each category in the catalog data based on a domain classifier;
wherein each of the predefined cluster is generated by comparing multiple normalized n-grams, derived from processing a plurality of full-term search queries, and grouping the semantically similar n-grams within a distinct cluster;
retrieving a domain specific context for each category in the catalog data wherein the domain specific context is based on the domain;
determining one or more enrichments for each of the plurality of tokens by:
enriching the catalog data by adding one or more enrichments for each of the plurality of tokens by identifying, using a Part of Speech (POS) tagger, a grammatical category for each of the plurality of tokens:
obtaining one or more synsets for each of the tokens pursuant to the grammatical category;
generating a target document for each of the one or more synset identified for each of the plurality of tokens from the catalog data wherein the target document comprises all terms retrieved from the synset for the said token in its tagged grammatical category:
creating a source document pursuant to the domain specific context of the product:
selecting a suitable synset, out of the one or more synsets, with the highest semantic similarity, based on comparison of each of the target document against the source document, using a pre-trained Artificial Intelligence (Al) model;
indexing enriched catalog data within one or more data stores communicably coupled to the processor:
enriching the catalog data by adding one or more enrichments for each of the plurality of tokens;
enriching the catalog data by adding one or more enrichments for each of the plurality of tokens; and
retrieving product listings with a larger recall pursuant to a user query.

2. (canceled)

3. The method of claim 1 wherein the pre-trained AI model is a Bidirectional Encoder Representations from Transformer (BERT) model.

4. The method of claim 1 wherein the domain specific context is supplemented with the catalog data.

5. The method of claim 1 wherein determining one or more enrichment further comprises identifying one or more class relations from a product ontology.

6. The method of claim 1 wherein one or more enrichment comprises merchant provided synonyms.

7-9 (canceled)

10. A system for enhancing search engine recall based on automated catalog data enrichment of a product based on analysis of user searches, the system comprising:
a processor configured to execute non-transitory machine readable instructions, wherein the processor is configured to:
receive a catalog data associated with the product wherein the catalog data comprises at least a product title;
process the catalog data into a plurality of tokens and pre-process each of the plurality of tokens;
identify a domain for each category in the catalog data based on a domain classifier based on a most similar match with one or more pre-defined set of clusters,
wherein each of the predefined cluster is generated by comparing multiple normalized n-grams, derived from processing a plurality of full-term search queries, and grouping the semantically similar n-grams within a distinct cluster;
retrieve a domain specific context for each category in the catalog data wherein the domain specific context is based on the domain and
wherein the domain specific context is generated for each of the pre-defined set of clusters;
determine one or more enrichments for each of the plurality of tokens wherein determining the one or more enrichment the processor is further configured to:
identify, using a Part of Speech (POS) tagger, a grammatical category for each of the plurality of tokens;
obtain one or more synsets for each of the tokens pursuant to the grammatical category:
generate a target document for each of the one or more synset;
create a source document pursuant to the context of the product;
select a suitable synset, out of the one or more synsets, with the highest semantic similarity using a pre-trained Artificial intelligence (AI) model;
enrich the catalog data by adding one or more enrichments for each of the plurality of tokens;
index enriched catalog data within one or more data stores communicably coupled to the processor; and
retrieve product listings with a larger recall pursuant to a user query.

11. (canceled)

12. The system of claim 10 wherein the pre-trained AI model is a Bidirectional Encoder Representations from Transformer (BERT) model.

13. The system of claim 10 wherein the domain specific context is supplemented with the catalog data.

14. The system of claim 10 wherein determining one or more enrichment further comprises identifying one or more class relations from a product ontology.

15. The system of claim 10 wherein one or more enrichment comprises merchant provided synonyms.

16-18 (canceled)

19. A search system comprising a processor configured to generate one or more product listings based on an input search query wherein the processor is communicably coupled to one or more data stores with enriched catalog data as per claim 10.

20. (canceled)
